(19) United States
(12) Patent Application Publication
(10) Pub. No.: US 2026/0189511 A1
(43) Pub. Date: Jul. 2, 2026

(54) RRC INACTIVE DATA TRANSMISSION METHOD, APPARATUS, AND COMPUTER-READABLE STORAGE MEDIUM

(71) Applicant: ZTE CORPORATION, Shenzhen, Guangdong (CN)

(72) Inventors: Zhuang LIU, Shenzhen (CN); Zijiang MA, Shenzhen (CN); Dapeng LI, Shenzhen (CN); Yin GAO, Shenzhen (CN)

(21) Appl. No.: 19/131,745

(22) PCT Filed: Apr. 4, 2023
(86) PCT No.: PCT/CN2023/086324

§ 371 Date: May 21, 2025

(51) Int. Cl. H04L 47/24; H04L 5/00; H04W 76/27

(52) U.S. Cl. CPC H04L 47/24; H04L 5/0044; H04W 76/27

(57) ABSTRACT

Wireless communication methods are disclosed. A wireless communication method includes sending, by a first base station (BS) to a core network (CN), SDT mapping information for setting up an SDT between the CN and the first BS; and the SDT according to a configuration set up according to the SDT mapping information.

### TECHNICAL FIELD

This disclosure is generally related to wireless communication, and more particularly wireless communication regarding data transmission in an RRC inactive status.

### BACKGROUND

Wireless communication technologies are pivotal components of the increasingly interconnecting global communication networks. Wireless communications rely on accurately allocated time and frequency resources for transmitting and receiving wireless signals. MT (Mobile-terminated) SDT (Small Data Transmission) allows a mobile to receive and transmit data in an RRC inactive state, but the technique is not mature yet.

### SUMMARY

This summary is a brief description of certain aspects of this disclosure. It is not intended to limit the scope of this disclosure.

According to some embodiments of this disclosure, a wireless communication is provided. The wireless communication method includes sending, by a first base station (BS) to a core network (CN), SDT mapping information for setting up SDT between the CN and the first BS; and performing the SDT according to a configuration set up according to the SDT mapping information.

According to some embodiments of this disclosure, a wireless communication is provided. The wireless communication method includes receiving, by a core network (CN) from a first base station (BS), SDT mapping information for setting up small data transmission (SDT) between the CN and the first BS; and performing the SDT according to a configuration set up according to the SDT mapping information.

Still another embodiment of this disclosure provides a wireless communication apparatus, including a memory storing one or more programs and a processor electrically coupled to the memory and configured to execute the one or more programs to perform any method or step or their combinations in this disclosure.

Still another embodiment of this disclosure provides non-transitory computer-readable storage medium, storing one or more programs, the one or more program being configured to, when performed by a processor, cause to perform any method or step or their combinations in this disclosure.

According to some embodiments of this disclosure, one or more wireless communication methods are further disclosed, the methods include combinations of certain methods, aspects, elements, and steps (either in a generic view or specific view) disclosed in the various embodiments of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows a communication diagram between two gNBs with exchanges of MT-SDT support capability.

FIG. 2 shows a communication diagram between a gNB and a CN with SDT traffic information and SDT mapping information.

FIG. 3 shows a communication diagram between a gNB and a CN with SDT mapping information and resource modify confirmation.

FIG. 4 shows a communication diagram regarding MT-SDT bearer information for CN.

FIG. 5 shows a communication diagram regarding CN initiated MT-SDT by directly sending small data.

FIG. 6 shows a communication diagram regarding CN initiated MT-SDT by NGAP signalling.

FIG. 7 shows a wireless communication structure.

FIG. 8 shows an exemplary wireless communication system according to embodiments of this disclosure.

### DETAILED DESCRIPTION

With the development of intelligent terminals (exemplarily implemented by user equipment (UE)) and IoT terminals, the number of users of some instant messaging services, such as WeChat, Twitter, QQ Message, and other applications is increasing. The services are usually online all the time when standing by and when the users send text messages, usually with a small volume of data transmission. Since the service of a small data volume requires the UE to frequently re-establish the signaling link with the Random Access Network (RAN), it will cause problems of, for example, increased signaling load on the RAN and the energy consumption on the UE becomes larger.

Certain new development supports an RRC inactive state for the UE, but however, the RRC inactive state doesn't support data transmission until the recent update. Hence, the UE has to resume the connection (i.e. move to an RRC connected state) for any downlink (DL) and uplink (UL) data transmission. Therefore, connection setting up and subsequently releasing to an inactive state happen for each data transmission, no matter how small and infrequent the data packets are. This approach results in unnecessary power consumption and signaling overhead.

The support of such small-packet infrequent transmissions has been recently addressed by the industry under the Small Data Transmission (SDT) feature, which enables UE in an RRC inactive state to perform data transmission. SDT is a procedure allowing data and/or signalling transmission while the UE remaining in an RRC inactive state (i.e. without transitioning to the RRC connected state). SDT is enabled on a radio bearer (RB) basis; for example, an SDT RB is a radio bearer configured with SDT function.

For UL small data transmission in the RRC inactive sate, UE can initiate the MO SDT (Mobile-Originated SDT) procedure for UL data. However, an issue for DL small data transmission in the RRC inactive sate still exists when eDRX (extended Discontinuous Reception) is used for UE for MT (mobile-terminated) SDT. eDRX is a technology used in cellular networks. It enables devices to stay in a low-power mode for longer periods of time by allowing them to “sleep” for extended periods of time without losing connection to the network.

In details, in order to save UE's power, long eDRX cycle (e.g. longer than 10.24 second) in the RRC inactive state can be configured to UE. With such setting, the UE is only required to monitor paging channels during one Paging Occasion (PO) in the long DRX cycle. However, with the long eDRX cycle, the gNB (or base station, BS) may have to wait for a long period (e.g. longer than 10.24 second) for data transmission until the UE is successfully paged. During this period, since CN (core network) does not know whether NG-RAN supports MT SDT or not, and does not know which QoS flow(s) is/are mapped to SDT DRB, the CN may need to buffer the downlink data of every QoS flow, regardless how small and infrequent the data packets are. Then, the NG-RAN have to page the UE to transfer to the RRC connected state for DL data transmission. Therefore, additional transmission latency for DL data transmission can be introduced.

### Exchanging MT-SDT Capability Information Between gNBs

According to some embodiment of this disclosure, different BSs may exchange information regarding whether the BS supports the MT-SDT, and therefore, a BS can use another BS to perform MT-SDT via the other BS.

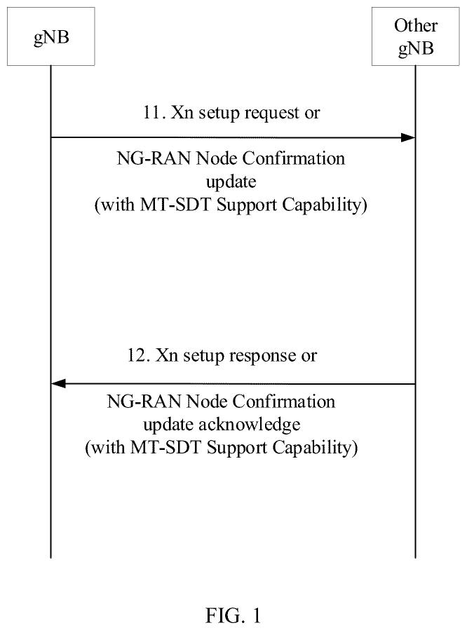

Referencing to step 11 of FIG. 1, the gNB can sends an Xn setup request or NG-RAN node configuration update message to other gNB to setup or modify the interface between the two gNBs. The Xn setup request or NG-RAN node configuration update message may include MT-SDT support capability information in the message. The MT-SDT support capability information can indicate whether a gNB supports the MT-SDT function for DL data or not.

Referencing to step 12 of FIG. 1, the other gNB receives the Xn setup request or the NG-RAN node configuration update message with the MT-SDT support capability information, and it can save the received MT-SDT support capability information in the message. The other gNB sends the Xn setup response or RAN configuration update acknowledge message to the first gNB. The Xn setup response or RAN configuration update acknowledge message may include the MT-SDT support capability information in the message, where the MT-SDT support capability information can indicate whether the gNB that sends the MT-SDT support capability information supports MT-SDT function for DL data or not.

Thereby, when an anchor gNB wants to page UE via another gNB for MT-SDT services, it can understand if the other gNB supports the MT-SDT function. The anchor gNB can send an XnAP paging messages to the other gNB, which includes a MT-SDT indicator in the paging messages to indicate that MT-SDT service is expected. Then the other gNB understands that the paging is for an MT-SDT service; therefore, the other gNB can include the MD-SDT indicator in an RRC paging message to UE.

### MT-SDT Bearer Information Provided to CN During PDU Session Setup/Modification Procedure

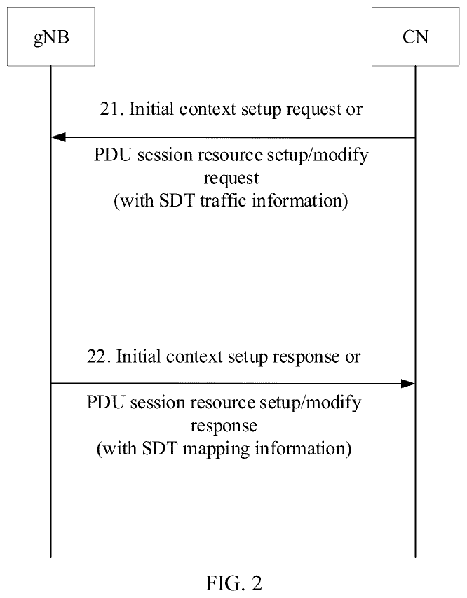

Referencing to step 21 in FIG. 2, the core network (CN) may send an initial context setup request or PDU session resource setup/modify message to the gNB to setup or modify resources of one or more PDU sessions for the UE. The initial context setup request or PDU session resource setup/modify message may include SDT traffic information, and the SDT traffic information may include at least one of the following: at least one SDT traffic indicator for respective QoS flow or at least one SDT traffic indicator for one PDU session and the underlying QoS flow(s) as a whole.

The at least one SDT traffic indicator corresponding to respective QoS flow may indicate the respective QoS flow with characteristics of DL and/or UL small data transmission, i.e, indicating the traffic of the corresponding QoS flow may include DL and/or UL SDT data in some period. Similarly, the at least one SDT traffic indicator on the level of the PDU session may indicate that all the QoS flow(s) in the corresponding PDU session possess characteristics of downlink and/or uplink small data transmission.

Referencing to step 22 in FIG. 2, the gNB receives SDT traffic information from the CN, and the gNB decides to map individual QoS flows to one or more SDT RBs for the UE based on the received SDT traffic information, including the SDT traffic indicator. For example, all the mapped QoS flow(s) in one SDT RB (a radio bearer supporting the SDT function) shall have the characteristics of downlink and/or uplink SDT indicated by the SDT traffic indicator in the SDT traffic information.

The gNB may sends the response message, e.g, initial context setup response, or PDU session resource setup/modify response, which includes SDT mapping information. According to some examples, the SDT mapping information includes at least one of: an SDT mapping indicator for respective QoS flow, an SDT mapping indicator corresponding to one PDU session and all underlying QoS flow(s), a downlink data volume threshold of all QoS flow(s) configured with SDT mapping indicator, or a downlink data volume threshold of all PDU session(s) configured with SDT mapping indicator.

The SDT mapping indicator for the respective QoS flow may indicate the corresponding QoS flow's mapping to an SDT RB. Similarly, the SDT mapping indicator for the PDU session (and its underlying QoS flow(s)) may indicate the mapping of all the QoS flow(s) in this PDU session to one or more SDT RB.

### MT-SDT Bearer Information for CN During PDU Session Modification Procedure Initiated by gNB

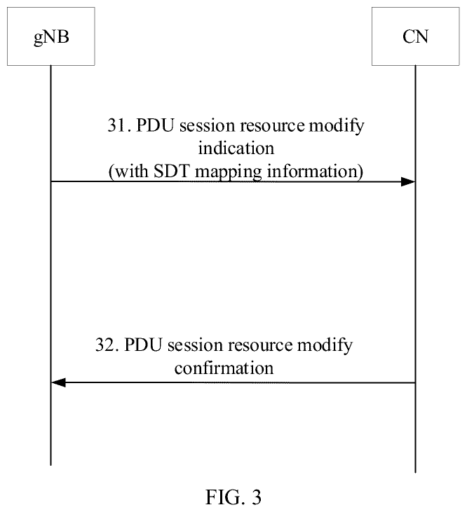

Referencing to Step 31 in FIG. 3, the gNB may sends an PDU session resource modify indication message to CN (Core Network) to modify the resource of one or more PDU sessions for the UE; the PDU session resource modify indication message may include the modified SDT mapping information in the message. The SDT mapping information may have the similar content explained above but with an updated information.

Referencing to Step 32 in FIG. 3, the CN receives SDT Mapping information, and updates its stored SDT mapping information. The CN may send a PDU session resource modify confirm message to the gNB.

Thereby, the updated information can be provided to the CN, and the CN can confirm the received update.

### MT-SDT Bearer Information for CN During Releasing UE to RRC Inactive State

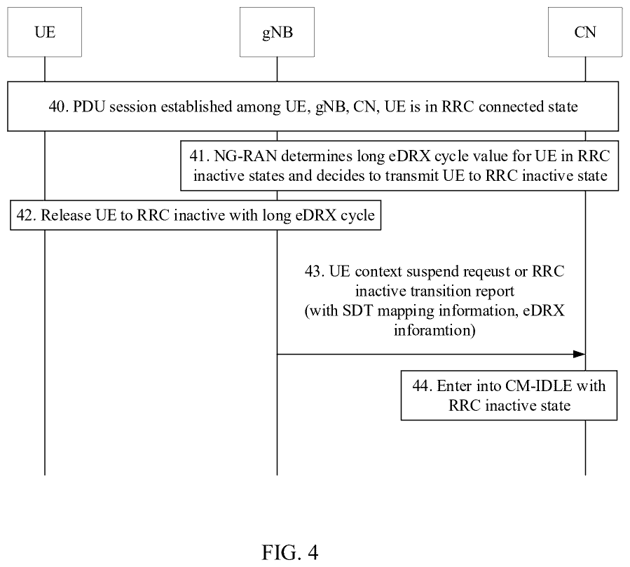

Referencing to Step 40 in FIG. 4, one or more PDU sessions have been established among the UE, gNB, and CN; in addition, the UE is in an RRC connected state.

Referencing to Step 41 in FIG. 4, the gNB can determine a long eDRX cycle value, for example, longer than 10.24 seconds, for the UE in an RRC inactive state and decide to transfer the UE to an RRC inactive state. Transferring the UE to an RRC inactive state may save the power consumption of the UE.

Referencing to Step 42 in FIG. 4, the gNB send an RRC message to the UE via radio interface to release the UE to an RRC inactive state with long eDRX cycle. The eDRX is a power-saving feature that allows devices to remain in a low-power mode for extended periods of time while still being able to receive incoming data. The eDRX cycle defines the duration for which the UE remains in the low-power mode before waking up to check for incoming data. The eDRX cycle can range from a few seconds to several hours, depending on the network and the application's requirements. During the eDRX cycle, the device's radio interface can be turned off, which significantly reduces power consumption. When the device wakes up to check for incoming data, it turns the radio interface back on and listens for incoming transmissions.

Referencing to Step 43 in FIG. 4, the gNB sends the RRC inactive transition report message to the CN to indicate that UE is in an RRC inactive state. The gNB can also send a UE context suspend request message to the CN to suspend the UE context for the UE to entering into the RRC inactive state. The RRC inactive transition report message or UE context suspend request message may include at least one of eDRX information (for example including, eDRX cycle value and paging time window for inactive) or SDT mapping information in the message as explained above.

Referencing to Step 44 in FIG. 4, the CN then enters into a CM-IDLE state with the RRC inactive state, and the CN stop transmitting DL data to the gNB. CM-IDLE is a power-saving state that allows devices to conserve battery power by reducing the frequency of communications with the network. In the CM-IDLE state, the device's radio interface can be turned off, and it may periodically wake up to check for incoming data.

### CN Initiated MT-SDT by Directly Sending Small Data

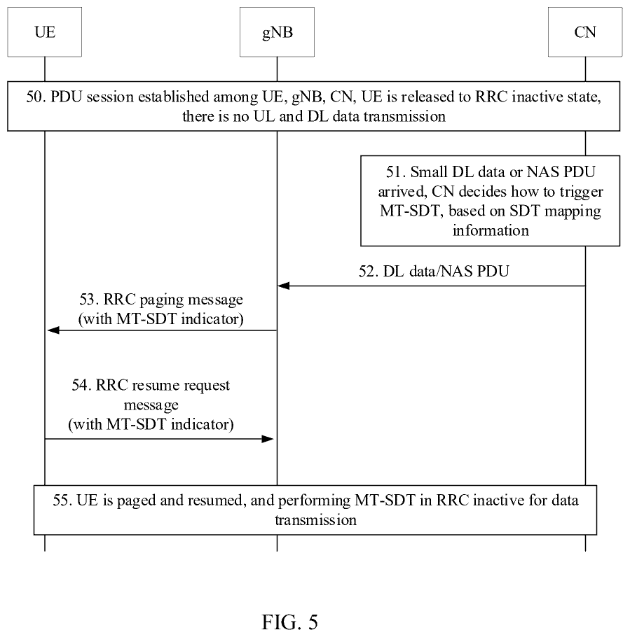

Referencing to Step 50 in FIG. 5, one or more PDU sessions have been established among the UE, gNB, and CN. After a period of data transmission, the UE may be released to an RRC inactive state.

Referencing to Step 51 in FIG. 5, the UE's user plane data or NAS PDU (Non-Access Stratum Protocol Data Unit) arrives at CN. The CN can decide whether to trigger MT-SDT and how to trigger MT-SDT based on the stored SDT mapping information. The CN can decide to send data and/or NAS PDU to gNB to trigger MT-SDT, if at least one of the following conditions (1) or (2) is met.
(1) When all arrived data at the CN belongs to the QoS flow(s) configured with an SDT mapping indicator and the data volume is less than (or alternatively not larger than) the configured downlink data volume threshold of all QoS flow(s).
(2) When all arrived data at the CN belongs to the PDU session(s) configured with an SDT mapping indicator and the data volume is less than (or alternatively not larger than) the configured downlink data volume threshold of all PDU session(s). The two conditions corresponding two possible implementations where an SDT mapping indicator may correspond to QoS flow(s) respectively or corresponds to an PDU session.

Referencing to Step 52 in FIG. 5, when the condition(s) is met, the CN sends DL data or NAS PDU to the gNB.

Referencing to Step 53 in FIG. 5, when the gNB receives the DL data or NAS PDU, the gNB understands that the arrived data is for the MT-SDT function. Then, the gNB can send an RRC paging message to UE to page the corresponding UE for the MT-SDT. The RRC paging message may include an MT-SDT indicator in the message to indicate to the UE that MT-SDT is expected. The RRC paging message is used to notify the UE that there is incoming data or a network event that requires the UE's attention. The RRC (Radio Resource Control) layer can be responsible for paging the UE and instructing it to initiate a connection with the network. The RRC paging message can be broadcasted by the network using the paging channel. The paging channel can be a dedicated channel that is used to transmit paging messages to all UEs that are in the RRC idle state and are listening for incoming data. The RRC paging message may further include information such as the identity of the UE, the type of incoming data or event, and the frequency and timing of the paging message. The RRC paging message can be transmitted using a specific paging format that includes the paging message header and the paging message content.

In addition, when an anchor gNB wants to page UE via other gNB for MT-SDT, if other gNB also supports MT-SDT function, the anchor gNB can send an Xn paging messages via an Xn interface to another gNB. The Xn paging messages contain an MT-SDT indicator to indicate that MT-SDT is expected. Then, the other gNB is aware of that the paging is for MT-SDT; therefore, the other gNB can include the MD-SDT indicator in the RRC paging message to be sent to the UE.

Similarly, when an anchor gNB, with an CU/DU (Centralized Unit/Distributed Unit) split architecture, wants to page UE via its DU for MT-SDT, the CU of the gNB can send an F1 paging messages via an F1 interface to its DU. The F1 paging messages contain an MT-SDT indicator to indicate to the DU that MT-SDT is expected. Then DU of the gNB is aware of that the paging is for MT-SDT; therefore, the DU can include the MD-SDT indicator in the an RRC paging message to be sent to the UE.

Referencing to Step 54 in FIG. 5, after the UE receives the RRC paging message, the UE sends an RRC resume request message to the gNB (such as a gNB-DU); the RRC resume request message includes a MT-SDT indicator to indicate MT-SDT is expected and to request resuming UE with an inactive state for MT-SDT.

Referencing to Step 55 in FIG. 5, the UE thereby resumes transmission with the gNB with an RRC inactive state, and the UE can transmit or receive subsequent MT-SDT data between UE and gNB via RACH (random access channel) or CG (cell group) resource.

### CN Initiated MT-SDT by NGAP Signalling

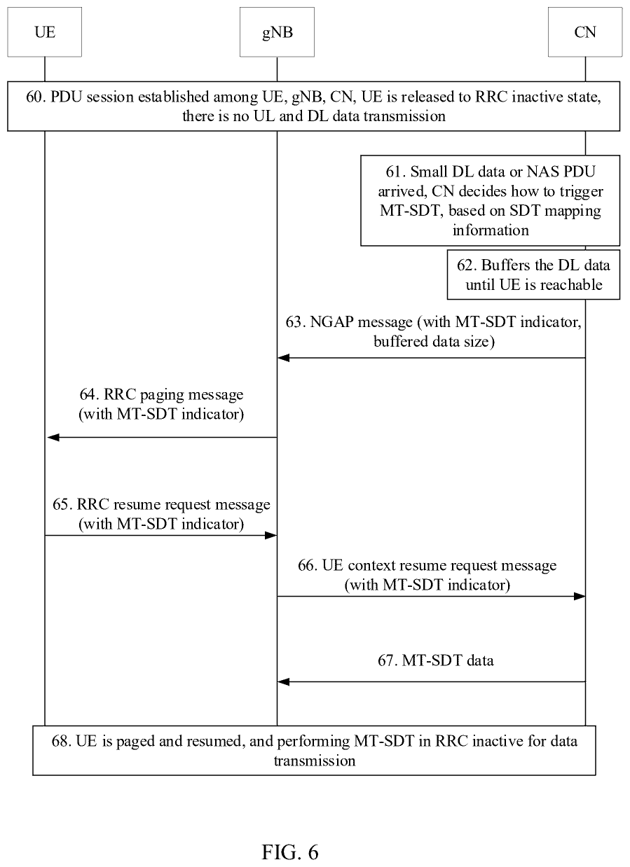

Referencing to Step 60 in FIG. 6, one or more PDU sessions have been established among the UE, gNB, and CN. After a period of data transmission, the UE may be released to an RRC inactive state.

Referencing to Step 61 in FIG. 6, the UE's user plane data or NAS PDU arrives at the CN. Thereby, the CN can decide whether to trigger MT-SDT and how to trigger the MT-SDT based on the stored SDT mapping information. For example, the CN can decide to send a NGAP (Next Generation Core Network (NGCN) Application Protocol) message to the gNB to trigger the MT-SDT if a downlink data volume threshold is not present in SDT mapping information and at least one of the following conditions is met: (1) if all arrived data belongs to at least one QoS flow(s) configured with an SDT mapping indicator; or (2) if all arrived data belongs to at least one PDU session(s) configured with an SDT mapping indicator.

Referencing to Step 62 in FIG. 6, the CN can buffer the DL data until the UE is reachable.

Referencing to Step 63 in FIG. 6, the CN can send a NGAP message to the gNB. The NGAP message may include at least one of: (1) an MT-SDT indicator to indicate MT-SDT is expected; (2) a buffered data size of all QoS flow(s) or PDU session(s) (with an SDT mapping indicator) to indicate the buffered data size for MT-SDT; (3) for one PDU session, a list of QoS flow(s) by which any data may arrive; (4) a list of PDU session(s) by which any data may arrive. The NGAP message could be a NGAP paging message, a DL data notification message, or a UE context resume required message, for example.

Referencing to Step 64 in FIG. 6, when the gNB receives the NGAP message, for one or more paging cells, the gNB may send an RRC paging message to UE to page the corresponding UE for the MT-SDT when at least one of the following conditions is met: (1) a MT-SDT indicator is received; or (2) buffered data size information is received, and the size is less than a MT-SDT threshold of the paging cell. That is, the gNB may determine whether it can support the use of SDT to transmit these buffered data based on its own network resources and buffered data size, and then the gNB may determine whether to carry the MT-SDT indicator to page the UE on the air interface. The paging messages may include a MT-SDT indicator to indicate MT-SDT is expected.

Similarly, when an anchor gNB wants to page UE via another gNB for MT-SDT, if the other gNB supports MT-SDT, the anchor gNB can send an Xn paging messages via an Xn interface to other gNB. The paging messages may include at least one of the following in the message: a MT-SDT indicator to indicate MT-SDT is expected; or buffered data size information of all QoS flow(s) or PDU session(s) with an SDT Mapping indicator to indicate the buffered data size for MT-SDT.

When the other gNB receives the Xn paging messages, the other gNB can decide how to send to RRC paging message to UE according to the step 64.

Similarly, when an anchor gNB, configured with a CU/DU (Centralized Unit/Distributed Unit) split architecture, wants to page UE via its DU for MT-SDT, the CU of the gNB can send an F1 paging messages via an F1 interface to its DU. The F1 paging messages may include at least one of the following in the message: a MT-SDT indicator to indicate MT-SDT is expected; or buffered data size information of all QoS flow(s) or PDU session(s) (with an SDT mapping indicator) to indicate the buffered data size for MT-SDT. When the DU receives the F1 paging messages, the DU of the gNB can decide how to send to RRC paging message to UE according to the step 64.

Referencing to Step 65 in FIG. 6, after the UE receive the RRC paging messages, the UE can send an RRC resume request message to the gNB (such as a gNB-DU). The RRC resume request message may include a MT-SDT indicator to indicate MT-SDT is expected and to request resuming UE with inactive state for MT-SDT.

Referencing to Step 66 in FIG. 6, after the UE successful resumed with an RRC inactive state, the gNB sends message to the CN via a NG interface to indicate the UE is reachable and is maintained in an RRC inactive for small data transmission. For example, the message sent by the gNB can be a UE context resume request or an RRC inactive transition report. The messages sent by the gNB can include a MT-SDT indicator in the message to trigger MT-SDT.

Referencing to Step 67 in FIG. 6, the CN then sends the DL small data to the gNB.

Referencing to Step 68 in FIG. 6, the UE can resume with the gNB at an RRC inactive state, to receive subsequent MT-SDT data between the UE and the gNB via RACH or CG (cell group) resource.

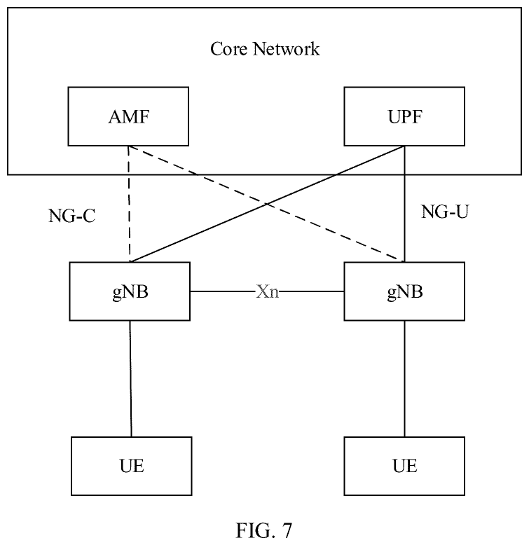

FIG. 7 is a system structure that can be used to implemented any steps, methods, or their combination in this disclosure. The Core Network is the core network architecture. It may include several network functions that work together to enable communication between the UE and the network. The 5G Core Network may have several network functions, including: AMF (Access and Mobility Management Function), SMF (Session Management Function), UPF (User Plane Function), NRF (Network Repository Function), and/or AUSF (Authentication Server Function).

The gNB stands for the Next-Generation NodeB or gNodeB. It is a kind of base stations in the 5G network that connects the UE to the 5G Core Network. The gNB is responsible for providing radio access to the UE and for transmitting and receiving the user data and control signals between the UE and the 5G Core Network. The gNB may support advanced features such as massive MIMO (Multiple Input Multiple Output), beamforming, and dynamic spectrum sharing to improve network capacity, coverage, and efficiency.

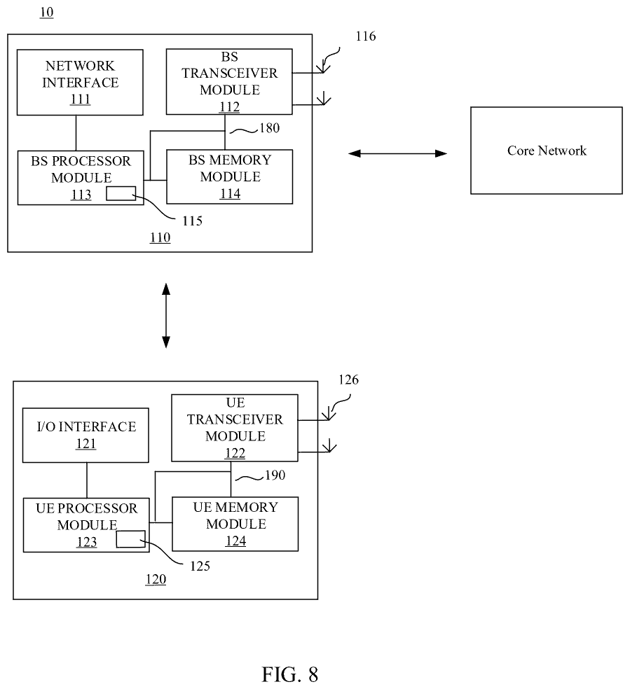

FIG. 8 illustrates a block diagram of an exemplary wireless communication system 10, in accordance with some embodiments of this disclosure. The system 10 may perform the various methods/steps disclosed in this disclosure. The system 10 may include components and elements configured to support operating features that need not be described in detail herein.

The system 10 may include a base station (BS) 110 and user equipment (UE) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE 120 includes a UE transceiver or transceiver module 122, a UE antenna system 126, a UE memory or memory module 124, a UE processor or processor module 123, and an I/O interface 121. The components of the UE 120 may be electrically coupled and in communication with one another as necessary via a data communication bus 190. The BS 110 communicates with the UE 120 via communication channels therebetween, which can be any wireless channel or other medium known in the art suitable for transmission of data as described herein.

The processor modules 113, 123 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, respectively, or in any practical combination thereof. The memory modules 113, 123 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124 may be coupled to the processor modules 113, 123 respectively, such that the processors modules 113, 123 can read information, instructions, or programs from, and write information to, memory modules 114, 124 respectively. The memory modules 114, 124 may also be integrated into their respective processor modules 113, 123. In some embodiments, the memory modules 114, 124 may each include a cache memory for storing temporary variables or other intermediate information during execution of instructions to be performed by processor modules 113, 123, respectively. The memory modules 114, 124 may also each include non-volatile memory for storing instructions to be performed by the processor modules 113, 123, respectively.

According to some embodiments of this disclosure, a wireless communication method is disclosed. The method includes sending, by a first base station (BS) to a core network (CN), SDT mapping information for setting up SDT between the CN and the first BS; and performing the SDT according to a configuration set up according to the SDT mapping information.

According to some examples, the SDT mapping information comprises at least one of: at least one SDT mapping indicator, wherein the at least one SDT mapping indicator indicates a mapping of at least one QoS flow to at least one SDT RB (Radio Bearer); or a first downlink (DL) data volume threshold.

According to some examples, the SDT mapping indicator corresponds to a PDU session and indicates the mapping of all the at least one QoS flow under the PDU session to at least one SDT RB as a whole.

According to some examples, the SDT mapping indicator corresponds to the respective QoS flow.

According to some examples, the first DL data volume threshold corresponds to a PDU session and all of its at least one QoS flow, or alternatively the first DL data volume threshold corresponds to the at least one QoS flow respectively.

According to some examples, the method further includes before sending the SDT mapping information, receiving, by the first BS from the CN, SDT traffic information, which includes: at least one SDT traffic indicator, which indicates characteristics of DL and/or uplink (UL) small data transmission of the at least one QoS flow.

According to some examples, the method further includes before sending the SDT mapping information, receiving, by the first BS from the CN, SDT traffic information, which includes: at least one SDT traffic indicator, which indicates characteristics of DL and/or UL small data transmission of all of at least one QoS flow under a PDU session.

According to some examples, the method further includes mapping the at least one QoS flow to at least one SDT RB according to the SDT traffic information.

According to some examples, receiving, by the first BS from the CN, the SDT traffic information comprises receiving, by the first BS from the CN, the SDT traffic information in an initial context set up request from the CN for the SDT or in a PDU session resource setup or modified message in a PDU session setup or modification procedure.

According to some examples, sending, by the first BS to the CN, the SDT mapping information comprises sending the SDT mapping information in a PDU session resource modify indication message.

According to some examples, the method further includes sending, by the first BS to the CN, at least one of: an RRC inactive transition report message to indicate user equipment (UE) is in an RRC inactive state, wherein the SDT mapping information is included in the RRC inactive transition report message; or a UE context suspend request message to suspend the UE context from entering into an RRC inactive state, wherein the SDT mapping information is included in the UE context suspend request message.

According to some examples, the method further includes receiving data, by the first BS from the CN via the SDT, when all data received by the CN belongs to at least one QoS flow configured by an SDT mapping indicator in the SDT mapping information, wherein the at least one SDT mapping indicator indicates a mapping of the at least one QoS flow to at least one SDT RB; and the data volume of the received data is less than a DL data volume threshold of the at least one QoS flow.

According to some examples, the method further includes receiving data, by the first BS from the CN via the SDT, when all data received by the CN belongs to at least one PDU session configured by the an SDT mapping indicator in the SDT mapping information, wherein the SDT mapping indicator indicates the mapping of all the at least one QoS flow under the PDU session to at least one SDT RB; and the data volume of the data is less than a configured DL data volume threshold of the at least one PDU session.

According to some examples, the method further includes receiving, by the first BS from the CN, a NGAP message to trigger the SDT when a setting of a DL data volume threshold is not presented in the SDT mapping information and all data received by the CN belongs to at least one QoS flow configured by the an SDT mapping indicator in the SDT mapping information, wherein the at least one SDT mapping indicator indicates a mapping of the at least one QoS flow to at least one SDT RB.

According to some examples, the method further includes receiving, by the first BS from the CN, a NGAP message to trigger the SDT when a setting of a DL data volume threshold is not presented in the SDT mapping information and all data received by the CN belongs to at least one PDU session configured by the an SDT mapping indicator in the SDT mapping information, wherein the SDT mapping indicator indicates the mapping of all the at least one QOS flow under the at least one PDU session to at least one SDT RB.

According to some examples, the NGAP message includes at least one of: an MT-SDT indicator to indicate to the BS that an MT-SDT transmission is expected; a buffered data size of all QoS flow(s) or all PDU session(s), with the SDT mapping indicator, to indicate the buffered data size for the MT-SDT; for one PDU session, a list of QoS flow(s) by which any data will arrive; or a list of PDU session(s) by which any data will arrive.

According to some examples, the NGAP message can be at least one of a NGAP paging message, a DL data notification, or a UE context resume request message.

According to some examples, the method further comprises sending, by the first BS, a Xn paging message via an Xn interface to a second BS, the Xn paging message including at least one of: an MT-SDT indicator to indicate an MT-SDT transmission is expected; or a buffered data size of all QoS flow(s) or all PDU session(s), with an SDT mapping indicator, to indicate the total buffered data size for the SDT.

According to some examples, the method further includes sending, by a Centralized Unit (CU) of the first BS, a F1 paging message via an F1 interface to a DU (Distributed Unit) of the first BS, the F1 paging message including at least one of: an MT-SDT indicator to indicate an MT-SDT transmission is expected; or a buffered data size of all QoS flow(s) or all PDU session(s), with an SDT mapping indicator, to indicate the total buffered data size for the MT-SDT.

According to some examples, the method further includes sending, by the first BS to the CN via a NG interface, a NGAP message to indicate a UE is reachable for SDT in an RRC inactive state, the NGAP message including an MT-SDT indicator to trigger the SDT.

According to some examples, the NGAP message includes a UE context resume request or an RRC inactive transition report.

According to some embodiments a wireless communication method is disclosed. The method includes: receiving, by a core network (CN) from a first base station (BS), SDT mapping information for setting up small data transmission (SDT) between the CN and the first BS; and performing the SDT according to a configuration set up according to the SDT mapping information.

According to some examples, the SDT mapping information comprises at least one of: at least one SDT mapping indicator, wherein the at least one SDT mapping indicator indicates a mapping of at least one QoS flow to at least one SDT RB (Radio Bearer); or a first downlink (DL) data volume threshold.

According to some examples, the SDT mapping indicator corresponds to a PDU session and indicates the mapping of all the at least one QoS flow under the PDU session to at least one SDT RB as a whole.

According to some examples, the SDT mapping indicator corresponds to the respective QOS flow.

According to some examples, the first DL data volume threshold corresponds to a PDU session and all of its at least one QoS flow, or alternatively the first DL data volume threshold corresponds to the at least one QoS flow respectively.

According to some examples, the method further includes before receiving the SDT mapping information, sending, by the CN to the first BS, SDT traffic information, which includes: at least one SDT traffic indicator, which indicates characteristics of DL and/or uplink (UL) small data transmission of the at least one QoS flow.

According to some examples, the method further includes before receiving the SDT mapping information, sending, by the CN to the first BS, SDT traffic information, which includes: at least one SDT traffic indicator, which indicates characteristics of DL and/or UL small data transmission of all of at least one QoS flow under a PDU session.

According to some examples, the SDT traffic information is used to map the at least one QoS flow to at least one SDT RB accordingly.

According to some examples, sending, by the CN to the first BS, the SDT traffic information comprises sending the SDT traffic information in an initial context set up request from the CN for the SDT or in a PDU session resource setup or modified message in a PDU session setup or modification procedure.

According to some examples, receiving, by the CN from the first BS, the SDT mapping information comprises receiving the SDT mapping information in a PDU session resource modify indication message.

According to some examples, the method further includes receiving, by the CN from the first BS, at least one of: an RRC inactive transition report message to indicate user equipment (UE) is in an RRC inactive state, wherein the SDT mapping information is included in the RRC inactive transition report message; or a UE context suspend request message to suspend the UE context from entering into an RRC inactive state, wherein the SDT mapping information is included in the UE context suspend request message.

According to some examples, the method further includes sending data, by the CN from to the first BS via the SDT, when all data received by the CN belongs to at least one QOS flow configured by an SDT mapping indicator in the SDT mapping information, wherein the at least one SDT mapping indicator indicates a mapping of the at least one QoS flow to at least one SDT RB; and the data volume of the received data is less than a DL data volume threshold of the at least one QoS flow.

According to some examples, the method further includes sending data, by the CN from to the first BS via the SDT, when all data received by the CN belongs to at least one PDU session configured by the an SDT mapping indicator in the SDT mapping information, wherein the SDT mapping indicator indicates the mapping of all the at least one QoS flow under the PDU session to at least one SDT RB; and the data volume of the data is less than a configured DL data volume threshold of the at least one PDU session.

According to some examples, the method further includes sending, by the CN to the first BS, a NGAP message to trigger the SDT when a setting of a DL data volume threshold is not presented in the SDT mapping information and all data received by the CN belongs to at least one QoS flow configured by the an SDT mapping indicator in the SDT mapping information, wherein the at least one SDT mapping indicator indicates a mapping of the at least one QoS flow to at least one SDT RB.

According to some examples, the method further includes sending, by the CN to the first BS, a NGAP message to trigger the SDT when a setting of a DL data volume threshold is not presented in the SDT mapping information and all data received by the CN belongs to at least one PDU session configured by the an SDT mapping indicator in the SDT mapping information, wherein the SDT mapping indicator indicates the mapping of all the at least one QoS flow under the at least one PDU session to at least one SDT RB.

According to some examples, the NGAP message comprises at least one of: an MT-SDT indicator to indicate to the BS that an MT-SDT transmission is expected; a buffered data size of all QoS flow(s) or all PDU session(s), with the SDT mapping indicator, to indicate the buffered data size for MT-SDT; for one PDU session, a list of QoS flow(s) by which any data will arrive; or a list of PDU session(s) by which any data will arrive.

According to some examples, the NGAP message is at least one of a NGAP paging message, a DL data notification, or a UE context resume request message.

According to some examples, the method further includes receiving, by the CN from the first BS via a NG interface, a NGAP message to indicate a UE is reachable for SDT in an RRC inactive state, the NGAP message including an MT-SDT indicator to trigger the SDT.

According to some examples, the NGAP message includes a UE context resume request or an RRC inactive transition report.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. information.

1. A wireless communication method, comprising:
sending, by a first base station (BS) to a core network (CN), SDT mapping information for setting up SDT between the CN and the first BS; and
performing the SDT according to a configuration set up according to the SDT mapping information.

2. The method of claim 1, wherein the SDT mapping information comprises at least one of:
at least one SDT mapping indicator, wherein the at least one SDT mapping indicator indicates a mapping of at least one QoS flow to at least one SDT Radio Bearer (RB); or
a first downlink (DL) data volume threshold.

3. The method of claim 2, wherein the SDT mapping indicator corresponds to a PDU session and indicates the mapping of all the at least one QoS flow under the PDU session to at least one SDT RB as a whole;
or, wherein the SDT mapping indicator corresponds to the respective QoS flow;
and/or, wherein the first DL data volume threshold corresponds to a PDU session and all of its at least one QoS flow, or alternatively the first DL data volume threshold corresponds to the at least one QoS flow respectively.

4. (canceled)

5. (canceled)

6. The method of claim 1, further comprising before sending the SDT mapping information, receiving, by the first BS from the CN, SDT traffic information, which comprises:
at least one SDT traffic indicator, which indicates characteristics of DL and/or uplink (UL) small data transmission of the at least one QoS flow;
or, at least one SDT traffic indicator, which indicates characteristics of DL and/or UL small data transmission of all of at least one QoS flow under a PDU session.

7. (canceled)

8. The method of claim 6, further comprising mapping the at least one QoS flow to at least one SDT RB according to the SDT traffic information;
and/or, wherein receiving, by the first BS from the CN, the SDT traffic information comprises receiving, by the first BS from the CN, the SDT traffic information in an initial context set up request from the CN for the SDT or in a PDU session resource setup or modified message in a PDU session setup or modification procedure.

9. (canceled)

10. The method of claim 1, wherein sending, by the first BS to the CN, the SDT mapping information comprises sending the SDT mapping information in a PDU session resource modify indication message;
and/or, the method further comprising sending, by the first BS to the CN, at least one of:
an RRC inactive transition report message to indicate user equipment (UE) is in an RRC inactive state, wherein the SDT mapping information is included in the RRC inactive transition report message;
or, a UE context suspend request message to suspend the UE context from entering into an RRC inactive state, wherein the SDT mapping information is included in the UE context suspend request message.

11. (canceled)

12. The method of claim 1, further comprising receiving data, by the first BS from the CN via the SDT, when
all data received by the CN belongs to at least one QoS flow configured by an SDT mapping indicator in the SDT mapping information, wherein the SDT mapping indicator indicates a mapping of the at least one QoS flow to at least one SDT RB; and
the data volume of the received data is less than a DL data volume threshold of the at least one QoS flow;
or, the method further comprising receiving data, by the first BS from the CN via the SDT, when
all data received by the CN belongs to at least one PDU session configured by an SDT mapping indicator in the SDT mapping information, wherein the SDT mapping indicator indicates the mapping of all the at least one QoS flow under the PDU session to at least one SDT RB; and
the data volume of the data is less than a configured DL data volume threshold of the at least one PDU session.

13. (canceled)

14. The method of claim 1, further comprising receiving, by the first BS from the CN, a NGAP message to trigger the SDT when a setting of a DL data volume threshold is not presented in the SDT mapping information and all data received by the CN belongs to at least one QoS flow configured by an SDT mapping indicator in the SDT mapping information, wherein the SDT mapping indicator indicates a mapping of the at least one QoS flow to at least one SDT RB;
or, the method further comprising: receiving, by the first BS from the CN, a NGAP message to trigger the SDT when a setting of a DL data volume threshold is not presented in the SDT mapping information and all data received by the CN belongs to at least one PDU session configured by an SDT mapping indicator in the SDT mapping information, wherein the SDT mapping indicator indicates the mapping of all the at least one QoS flow under the at least one PDU session to at least one SDT RB.

15. (canceled)

16. The method of claim 14, wherein the NGAP message comprises at least one of:
an MT-SDT indicator to indicate to the BS that an MT-SDT transmission is expected;
a buffered data size of all QoS flow(s) or all PDU session(s) to indicate the buffered data size for the SDT;
for one PDU session, a list of QoS flow(s) by which any data will arrive; or
a list of PDU session(s) by which any data will arrive;
or, wherein the NGAP message is at least one of a NGAP paging message, a DL data notification, or a UE context resume request message.

17. (canceled)

18. The method of claim 1, further comprising sending, by the first BS, a Xn paging message via an Xn interface to a second BS, the Xn paging message including at least one of:
an MT-SDT indicator to indicate an MT-SDT transmission is expected; or
a buffered data size of all QoS flow(s) or all PDU session(s) to indicate the total buffered data size for the SDT;
or, the method further comprising sending, by a Centralized Unit (CU) of the first BS, a F1 paging message via an F1 interface to a Distributed Unit (DU) of the first BS, the F1 paging message including at least one of:
an MT-SDT indicator to indicate an MT-SDT transmission is expected; or
a buffered data size of all QoS flow(s) or all PDU session(s) to indicate the total buffered data size for the SDT.

19. (canceled)

20. The method of claim 1, further comprising sending, by the first BS to the CN via a NG interface, a NGAP message to indicate a UE is reachable for SDT in an RRC inactive state, the NGAP message including an MT-SDT indicator to trigger the SDT;
preferably, wherein the NGAP message includes a UE context resume request or an RRC inactive transition report.

21. (canceled)

22. A wireless communication method, comprising:
receiving, by a core network (CN) from a first base station (BS), SDT mapping information for setting up small data transmission (SDT) between the CN and the first BS; and
performing the SDT according to a configuration set up according to the SDT mapping information.

23. The method of claim 22, wherein the SDT mapping information comprises at least one of:
at least one SDT mapping indicator, wherein the at least one SDT mapping indicator indicates a mapping of at least one QoS flow to at least one SDT Radio Bearer (RB); or
a first downlink (DL) data volume threshold.

24. The method of claim 23, wherein the SDT mapping indicator corresponds to a PDU session and indicates the mapping of all the at least one QoS flow under the PDU session to at least one SDT RB as a whole;
or, wherein the SDT mapping indicator corresponds to the respective QoS flow;
and/or, wherein the first DL data volume threshold corresponds to a PDU session and all of its at least one QoS flow, or alternatively the first DL data volume threshold corresponds to the at least one QoS flow respectively.

25. (canceled)

26. (canceled)

27. The method of claim 22, further comprising before receiving the SDT mapping information, sending, by the CN to the first BS, SDT traffic information, which comprises:
at least one SDT traffic indicator, which indicates characteristics of DL and/or uplink (UL) small data transmission of the at least one QoS flow; or
at least one SDT traffic indicator, which indicates characteristics of DL and/or UL small data transmission of all of at least one QoS flow under a PDU session.

28. (canceled)

29. The method of claim 27, wherein the SDT traffic information is used to map the at least one QoS flow to at least one SDT RB accordingly;
and/or, wherein sending, by the CN to the first BS, the SDT traffic information comprises sending the SDT traffic information in an initial context set up request from the CN for the SDT or in a PDU session resource setup or modified message in a PDU session setup or modification procedure.

30. (canceled)

31. The method of claim 22, wherein receiving, by the CN from the first BS, the SDT mapping information comprises receiving the SDT mapping information in a PDU session resource modify indication message;
and/or, the method further comprising receiving, by the CN from the first BS, at least one of:
an RRC inactive transition report message to indicate user equipment (UE) is in an RRC inactive state, wherein the SDT mapping information is included in the RRC inactive transition report message; or
a UE context suspend request message to suspend the UE context from entering into an RRC inactive state, wherein the SDT mapping information is included in the UE context suspend request message.

32. (canceled)

33. The method of claim 22, further comprising sending data, by the CN to the first BS via the SDT, when
all data received by the CN belongs to at least one QoS flow configured by an SDT mapping indicator in the SDT mapping information, wherein the SDT mapping indicator indicates a mapping of the at least one QoS flow to at least one SDT RB; and
the data volume of the received data is less than a DL data volume threshold of the at least one QOS flow;
or, the method further comprising sending data, by the CN to the first BS via the SDT, when
all data received by the CN belongs to at least one PDU session configured by an SDT mapping indicator in the SDT mapping information, wherein the SDT mapping indicator indicates the mapping of all the at least one QoS flow under the PDU session to at least one SDT RB; and
the data volume of the data is less than a configured DL data volume threshold of the at least one PDU session.

34. (canceled)

35. The method of claim 22, further comprising sending, by the CN to the first BS, a NGAP message to trigger the SDT when a setting of a DL data volume threshold is not presented in the SDT mapping information and all data received by the CN belongs to at least one QoS flow configured by an SDT mapping indicator in the SDT mapping information, wherein the SDT mapping indicator indicates a mapping of the at least one QoS flow to at least one SDT RB;
or, further comprising sending, by the CN to the first BS, a NGAP message to trigger the SDT when a setting of a DL data volume threshold is not presented in the SDT mapping information and all data received by the CN belongs to at least one PDU session configured by an SDT mapping indicator in the SDT mapping information, wherein the SDT mapping indicator indicates the mapping of all the at least one QoS flow under the at least one PDU session to at least one SDT RB.

36. (canceled)

37. The method of claim 35, wherein the NGAP message comprises at least one of:
an MT-SDT indicator to indicate to the BS that an MT-SDT transmission is expected;
a buffered data size of all QoS flow(s) or all PDU session(s) to indicate the buffered data size for MT-SDT;
for one PDU session, a list of QoS flow(s) by which any data will arrive; or
a list of PDU session(s) by which any data will arrive;
or, wherein the NGAP message is at least one of a NGAP paging message, a DL data notification, or a UE context resume request message.

38. (canceled)

39. The method of claim 22, further comprising receiving, by the CN from the first BS via a NG interface, a NGAP message to indicate a UE is reachable for SDT in an RRC inactive state, the NGAP message including an MT-SDT indicator to trigger the SDT;
preferably, wherein the NGAP message includes a UE context resume request or an RRC inactive transition report.

40. (canceled)

41. A wireless communication apparatus, comprising a memory storing one or more programs and one or more processors electrically coupled to the memory and configured to:
send, by a first base station (BS) to a core network (CN), SDT mapping information for setting up SDT between the CN and the first BS; and
perform the SDT according to a configuration set up according to the SDT mapping information.

42. (canceled)
